(19) United States
(12) Patent Application Publication
(10) Pub. No.: US 2002/0062215 A1
(43) Pub. Date: May 23, 2002

(54) Method and apparatus for sorting veneer carpets

(76) Inventor: Carsten Runge, Bad Essen (DE)

Correspondence Address: BLANK ROME COMISKY & MCCAULEY, LLP, The Farragut Building, Suite 1000, 900 17th Street, NW, Washington, DC, 20006, US

(21) Appl. No.: 09/731,658

(22) Filed: Dec. 8, 2000

(30) Foreign Application Priority Data
Nov. 22, 2000 (EP) 00125601.5

(51) Int. Cl. G10L 21/00

(52) U.S. Cl. 704/270

(57) ABSTRACT

The present invention relates to a method for sorting veneer carpets, wherein the veneer carpets are classified into various classes according to predetermined criteria, such as size, appearance, quality, etc., and the chosen class is input via speech recognition which the operator informs about the chosen classification of the respective veneer carpet via audio signals.

Furthermore, the present invention relates to an apparatus for carrying out the method.

Said measures shall provide a method and an apparatus which ensure a faster, easier and more reliable input of the chosen classification.

### DESCRIPTION

The present invention relates to a method and an apparatus for sorting veneer carpets.

Veneer carpets are produced for different purposes and products. They serve, inter alia, to line doors, furniture, paneling, etc.

When veneer carpets are produced, individual veneer pieces are connected to one another to form veneer carpets. This is accomplished on so-called veneer assembling machines. Especially in big factories, large quantities of veneer carpets are produced. Since different qualities and/or different sizes are required for different purposes, a sorting operation has to be carried out after production of the veneer carpets for sorting the veneer carpets, for instance according to the quality of the veneers, such as grain, color, or the like, or on the basis of the images produced by the grain of the wood, according to the quality of the joints or according to size. To this end the veneer carpets which are stacked on pallets, or the like, are classified by an operator visually or, alternatively, by a camera system in combination with an image evaluating means.

When a classification into a specific category has been made by the operator or by the camera system, the operator must supply the veneer carpet just classified from the pallet, or the like, to a processing means, such as a trimming or final gluing machine, or to a transporting means which conveys the classified veneer carpets to a veneer stack assigned to the associated class.

On account of the size of the veneer carpet, the operator must often seize the veneer carpet with both of his hands in order to place it on the transporting means or to feed it to the processing means. However, since he already needs both of his hands for handling the veneer carpets, it is no longer possible to define the chosen classification for the respective veneer carpet, for instance by way of a manual input. This can only be carried out before or after the handling of the respective veneer carpet. As a consequence, however, there is not only a delay in the further processing or in the transportation of the veneer carpet, but there may also be errors during input, e.g. when the operator's attention has been diverted and he has thus forgotten the chosen class as such or when he has not entered the chosen class because of the disturbance.

It is therefore the object of the present invention to provide a method and an apparatus of the above-mentioned type which ensures a faster, easier and more reliable input of the chosen classification.

This object is achieved with respect to the method by the features indicated in claim 1.

Since the classification is entered via speech recognition, the selected class can directly be input while the veneer carpet is handled. A faster handling is thereby made possible and error sources are minimized by virtue of the simplified input. Acceptance by the operator is also improved because he no longer needs to press any buttons for indicating the chosen class, but can easily input the appropriate class verbally.

This object is further achieved with respect to the apparatus by the features indicated in claim 6.

Since the apparatus is equipped with a device for speech input, in particular a microphone, that is provided within the operator's area of movement, it is easily possible for the operator to input the chosen classification directly while he is handling the veneer carpet, i.e., even in cases where none of his hands are free. This reduces the operator's work load and effects a faster processing of the veneer carpets.

Advantageous developments are indicated in the subclaims.

When according to an advantageous development the information contained in the audio signals controls the transportation and/or further processing of the veneer carpets through speech recognition, it is guaranteed that a reliable and error-free processing of the veneer carpets can be carried out according to the respective audio signals.

To prevent unintended noise from causing a wrong storage of the veneer carpet or disturbance of the sorting system, the audio signals are recorded according to the invention only during a defined period of time. It can thus be ensured that only the desired information is used for influencing the control means. The period for recording the audio signals is indicated to the operator acoustically and/or optically according to an advantageous development. To this end there may be provided an acoustic and/or optical display device which indicates the period that is available for recording the audio signals. As a result of such a display, the operator knows exactly when he can influence the control means via audio signals. This enhances the reliability of the classification.

To avoid a situation in which not any possible audio signal can influence the control means, an identification software is provided according to a preferred development for comparing the audio signal input with a predetermined sequence. When the predetermined sequences are assigned to the storage places, an error-free assignment to the individual storage places can be ensured through this measure.

To avoid an unnecessary limitation of the area of movement of the operator, the device for speech input may also be provided on the operator according to a preferred development.

Since for reasons of noise protection headphones can also be worn by the operator in many cases, it is particularly advantageous when the speech input device is provided on a headphone worn by the operator. The signal for indicating the input period can preferably be output through this headphone as well. Thus input and output devices can be combined with one another in a useful way, and aspects regarding industrial safety can additionally be taken into account.

To ensure in such a case that the operator's freedom of movement is not restricted by cables, or the like, the transmission from the speech input device and to the headphone is wireless.

Further advantages, features and developments of the present invention will become apparent from the description of a preferred embodiment.

The veneer carpets which are stacked on pallets, or the like, are classified by an operator visually or via a camera system in combination with an image evaluating means. While the operator picks up the veneer carpet just classified from the pallet, or the like, and supplies it to a processing means, a speech input device, such as a microphone, which is provided within the area of movement of the operator is switched on for a defined period of time. This period is made known to the operator via optical and/or acoustic signals. During this period the operator speaks into the microphone to indicate the chosen classification. A speech recognition means compares the spoken audio sequence with predetermined sequences which are assigned to the storage places in the sorting system, and controls product flow and transportation to one of the storage places on the basis of the information gained, e.g. by activating gates via which the veneer carpet is supplied to the respective storage place.

The speech input device may also be provided on the operator himself, for instance, on his clothes, or may be connected to a headphone through which the acoustic signal may then also be output for indicating the input period. To avoid an unnecessary limitation of the operator's freedom of movement in such an instance, the transmission may also be wireless.

The classified veneer carpets are conveyed along a transportation path at which several storage places are located. The storage places may e.g. be formed by pallets, or the like. Each pallet is assigned to a specific class. The veneer carpets are transported by a transportation means, e.g. in the form of belts, along the transportation path. When the veneer carpets have reached the area of their class, the belts of the transportation means can be moved vertically such that the veneer carpet can be removed from the transportation means upwards, downwards or also to the side to be deposited on a stack in the area of its class. The veneer carpet may be deposited such that it is gripped at one edge, e.g. on its front edge, and pulled over the existing veneer stack up to the front edge thereof and is there deposited in a specific position.

Along the transportation path at least as many storage places are present as classes are to be formed. However, it is also possible to provide a few additional unoccupied storage places. For instance, when a veneer stack has reached its maximum stacking height at a storage place, one of these unoccupied storage places may be provided with the classification of the occupied storage place by the control means provided in connection with speech recognition, so that the veneer carpets are conveyed to this new storage place from now on. At the same time, the control device may produce a message that there is a full pallet at a storage place. This pallet can now be replaced by a new, empty one. A continuous operation of the sorting system is guaranteed because of this measure.

1. A method for sorting veneer carpets, wherein said veneer carpets are classified into different classes according to predetermined criteria, such as size, appearance, quality, etc., and the chosen class is input via speech recognition which the operator informs about the chosen classification of the respective veneer carpet through audio signals.

2. The method according to claim 1, wherein the information contained in said audio signals controls transportation and/or further processing of said veneer carpets through speech recognition.

3. The method according to any one of the preceding claims, wherein said audio signals are only recorded within a defined period of time.

4. The method according to any one of the preceding claims, wherein the period for recording the audio signals is indicated to the operator acoustically and/or optically.

5. The method according to any one of the preceding claims, wherein an identification software compares the audio signal input with a predetermined sequence.

6. An apparatus for carrying out the method according to claim 1, wherein a device for speech input, in particular a microphone, is provided within the area of movement of the operator.

7. The apparatus according to claim 6, wherein an acoustic and/or optical display device is provided which indicates the period that is available for recording the audio signals.

8. The apparatus according to claim 6 or 7, wherein said speech input device is provided on the operator.

9. The apparatus according to any one of claims 6 to 8, wherein said speech input device is provided on a headphone worn by the operator, through which the signal for indicating the input period is also output.

10. The apparatus according to any one of claims 6 to 9, wherein transmission from said speech input device and to said headphone is wireless.
